(19) United States
(12) Patent Application Publication
(10) Pub. No.: US 2006/0063590 A1
(43) Pub. Date: Mar. 23, 2006

(54) Mechanism to control game usage on user devices

(76) Inventors: Paul Abassi, Palo Alto, CA (US); Robert Riley, Oak Park, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/946,943

(22) Filed: Sep. 21, 2004

(51) Int. Cl. A63F 13/00

(52) U.S. Cl. 463/29; 463/42

(57) ABSTRACT

A method and system for controlling game usage on user devices are described. In one embodiment, the method includes identifying a game selected by a user for a first user device, determining that the game has been previously purchased by the user for a second user device, and causing the game to be available to the user for playing on the first user device.

### FIELD OF THE INVENTION

The present invention relates to wireless games; more particularly, the present invention relates to controlling game usage on user devices.

### BACKGROUND OF THE INVENTION

Electronic games have become a major part of the entertainment industry in today's modern world. The playing of electronic games on stand-alone terminals has long been popular. However, in recent years these games have migrated into a network environment, including a wireless network environment.

In a wireless network environment, manufacturers and publishers of electronic games typically do not interact with end users directly. That is, end users usually purchase electronic games and receive game-related services from wireless carriers (e.g., AT&T®, Sprint PCS®, Verizon®, etc.). As a result, game player communities are limited to users of a specific wireless carrier. In addition, because manufactures and publishers of electronic games cannot develop direct relationships with game players, they are unable to collect detailed information about game players and to facilitate targeted advertisements of new games. Moreover, if a user purchases a game from one wireless carrier and then switches to a mobile phone of a different wireless carrier, the user has to purchase this game again from the different wireless carrier to be able to play it on the new phone.

### SUMMARY OF THE INVENTION

A method and system for controlling game usage on user devices are described. According to one aspect, the method includes identifying a game selected by a user for a first user device, determining that the game has been previously purchased by the user for a second user device, and causing the game to be available to the user for playing on the first user device.

Other features of the present invention will be apparent from the accompanying drawings and from the detailed description that follows.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of a system in which embodiments of the present invention may operate.

FIG. 2A is a block diagram of one embodiment of a game management system.

FIG. 2B is a block diagram of one embodiment of a gaming data module.

FIGS. 3 and 4 are flow diagrams of two embodiments of a process for controlling usage of an electronic game with user devices.

FIG. 5 is a flow diagram of one embodiment of a game advertisement process.

FIG. 6 illustrates one embodiment of a game unlock process.

FIGS. 7-12 are flow diagrams illustrating various embodiments of game unlocking processes.

FIG. 13 is a block diagram of an exemplary computer system.

### DETAILED DESCRIPTION OF THE PRESENT INVENTION

A method and apparatus for controlling game usage on user devices are described. In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Overview

Embodiments of the present invention allow providers of electronic games to manage players' usage of electronic games. Providers of electronic games may include game manufacturers, game publishers, wireless carriers, or any other entities controlling user access to electronic games.

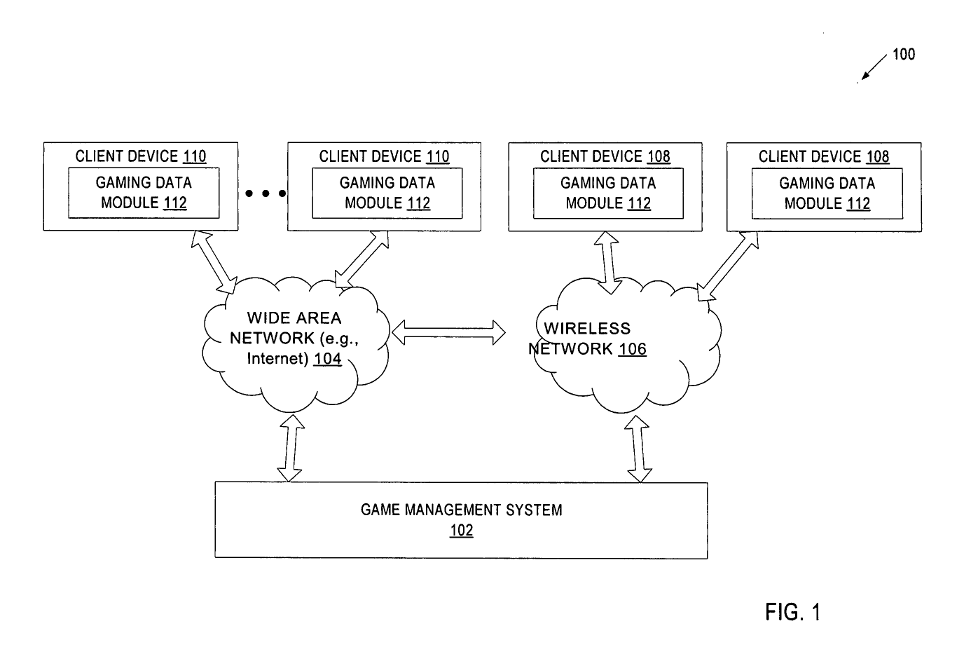

FIG. 1 is a block diagram of one embodiment of a system 100, in which embodiments of the present invention may operate. The system 100 includes a wide area network (e.g., Internet) 104, a wireless network 106, client devices 108 and 110, and a game management system 102.

The client devices 108 are mobile devices coupled to the game management system 102 via the wireless network 106. Mobile devices 108 are interactive two-way communication devices that allow their users to play wireless games. For example, the mobile devices 108 may be wireless telephones, palm-sized computing devices, personal digital assistants (PDAs), etc. Such two-way communication devices may communicate wirelessly with the game management system 102 via the wireless network 106. Communication between the game management system 102 and the mobile devices 108 is provided by corresponding wireless carriers (e.g., AT&T®, Sprint PCS®, Verizon®, etc.).

The client devices 110 are coupled to the game management system 102 via the wide area network 104 (e.g., Internet). The client devices 108 are interactive two-way communication devices that allow their users to play console games, web games or personal computer (PC) games. For example, the client devices 110 may be PC systems, personal digital assistants (PDA)s, play stations, consumer electronic devices, etc.

In one embodiment, client devices 108 and 110 host client-based applications such as gaming data modules 112 that collect data associated with games played on relevant client devices 108 and 110, and provide this data to the game management system 120. In one embodiment, the gaming data module 112 is configured based on the platform of a relevant client device 108 or 110. In one embodiment, the gaming data module 112 is integrated into a game played on a relevant client device 108 or 110. In another embodiment, the gaming data module 112 is an independent application residing on a relevant client device 108 or 110.

The game management system 102 provides services to deploy, manage and support games on the client devices 108 and 110, thus providing game services across different device platforms (e.g., PC platforms, wireless device platforms, web-based hand-held device platforms, game console platforms, etc.). The game management system 102 may be maintained by a game manufacturer, a game publisher, a network communication carrier, or any other provider of game services.

In one embodiment, the game management system 102 cooperates with the gaming data modules 112 to enable two-way messaging with applications on the client devices 108 and 110. In one embodiment, the gaming data modules 112 forward messages (and store messages when the client device is disconnected from the network) to the game management system 102 and support real-time in-game features (e.g., in-game advertisement, multi-player gameplay, user registration, game metric collection, etc.) facilitated by the game management system 102.

In one embodiment, scalability of the game management system 102 is provided by utilizing multiple servers. For example, each type of client applications may be associated with one or more designated servers. In addition, for wireless client applications, each wireless carrier may be associated with one or more designated servers. For example, each carrier may be associated with a designated database server (e.g., a 4-CPU database server) and accompanying application servers (e.g., six web application servers). Alternatively, some wireless carriers may share servers. If any server or group of servers performs inadequately, the system is reconfigured to provide services for users of an associated carrier by another group of servers.

Game Management System

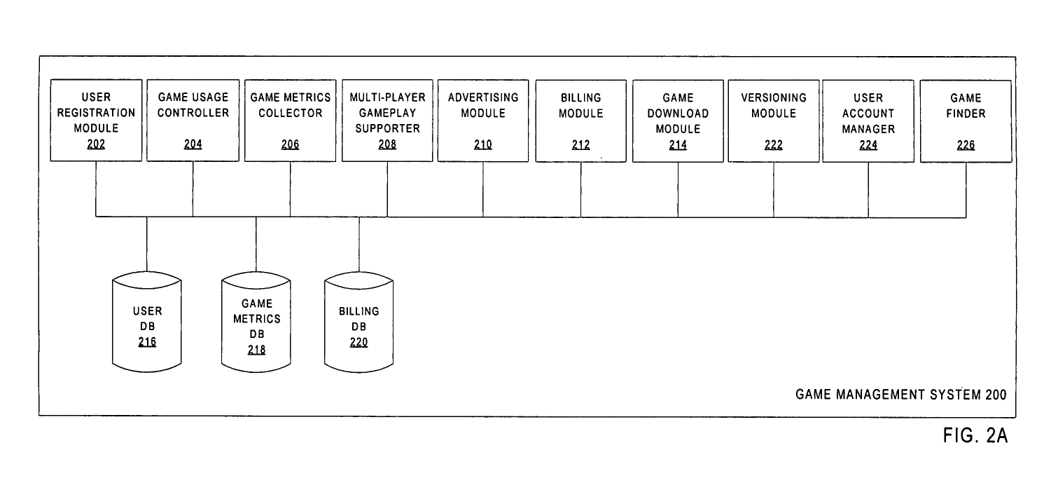

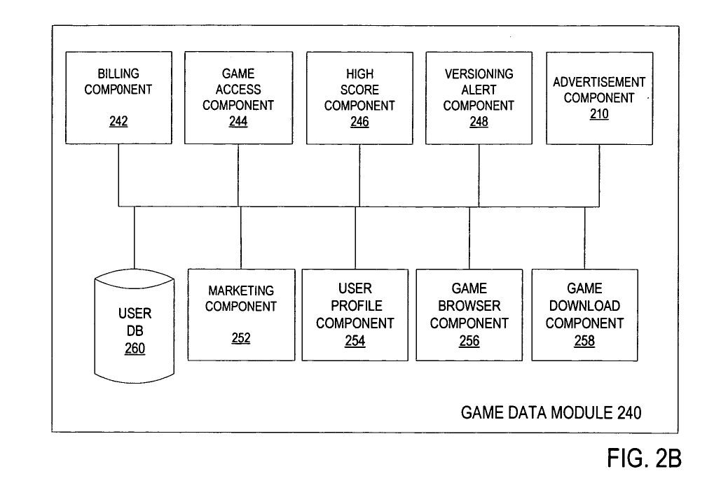

FIG. 2A is a block diagram of one embodiment of a game management system 200. In one embodiment, the game management system 200 supports mobile or wireless games. In another embodiment, the game management system 200 also supports games of other types such as PC games, web games and console games.

The game management system 200 may include a user registration module 202, a game usage controller 204, a game metrics collector 206, a multi-player gameplay supporter 208, an advertising module 210, a billing module 212, a game download module 214, a versioning module 222, a user account manager 224, a game finder 226, a user database 216, a game metrics database 218, a billing database 220, and/or various other modules not shown in FIG. 2.

The user registration module 202 is responsible for registering new users, storing identifying information of new users in the user database 216, and facilitating login of existing users. A user registration process may be invoked upon a user activation of a registration link on a web site associated with the game management system 200, upon a user request to download a game to the user's client device 108 or 110, upon a user attempt to begin playing a new game, or upon any other event initiated by the user. The user identifying information may include, for example, a user ID, a password, an email address, a unique code associated with the game selected by the user, etc.

The game usage controller 204 is responsible for receiving information associated with a user purchase of a new game, storing this information in the user database 216, and controlling the usage of this game on various user devices. The game usage controller 204 may receive information associated with the purchase of a new game from the billing module 210 when a purchase is facilitated by the game management system 200, from the user registration module 202 when the user registers a game with the game management system, or from an external system facilitating the purchase of a new game. In one embodiment, if the user purchases a new game for a specific mobile device 106, the game usage controller 204 records the purchase in the user database 216. Subsequently, when the user selects this game for a different mobile device, the game usage controller 204 finds the record associated with the selected game in the user database 216 and causes this game to be available to the user for playing on the other mobile device. The game usage controller 204 may also cause, in one embodiment, a game purchased for a mobile device 106 to be available to the user for playing on a PC, a hand-held computer, a game console or any other device 108. Similarly, the game usage controller 204 may cause, in one embodiment, a game purchased for a non-mobile device 108 to be available to the user for playing on mobile devices 106. In addition, the game usage controller 204 may allow the user to re-download the game to the same client device if the user has previously erased the game from the client device (e.g., due to space considerations).

In one embodiment, the game usage controller 204 causes a game to be available to a user if the user satisfies one or more game unlocking criteria (e.g., the number of game unlocks does not exceed a predefined threshold). In one embodiment, the game usage controller 204 can also cause a game to be unavailable or no longer available to the user upon determining that the user satisfies one or more game locking criteria (e.g., the user is delinquent).

The game metrics collector 206 is responsible for receiving game metrics from players of various games and storing the game metrics in the game metrics database 218. The game metrics may specify, for example, the version of a played game, the score of the game, how long the game was played, etc. The game metrics may be used by game producers and publishers to analyze gameplay and conduct data mining. The game metrics controller 206 may also be responsible for producing reports based on game metrics (e.g., reports by title and carrier to evaluate the performance of games by titles and genre).

The multi-player gameplay supporter 208 is responsible for providing multi-player features across different device platforms (e.g., PC platforms, wireless device platforms, web-based hand-held device platforms, game console platforms, etc.). The multi-player features may include, for example, facilitating matching of players for a game (e.g., by allowing a search of players by name, rank or range of ranks), managing player turns in a game, supporting exchange of in-game chat messages, maintaining lobbies for different games to allow game players to exchange information, search for available players/teams and times, set up head-to-head games, etc. In one embodiment, the multi-player gameplay supporter 208 is also responsible for collecting high-score data (e.g., users' names and scores) from client devices, comparing the scores of different users, returning a list of top scores to the client devices, and notifying a user if he or she earned a high score. In addition, the multi-player gameplay supporter 208 may rank game players (e.g., based on losses, wins and difficulty of played games), provide player rankings to the users upon their requests, initiate (or allow users to initiate) tournaments and define (or allow users to define) criteria for participation in tournaments.

In one embodiment, the multi-player gameplay supporter 208 is further responsible for periodically checking whether each player is still connected to the network. In addition, a threshold can be set to mark a game-validation point at which the game will be treated differently if any player is dropped from the network. This feature allows differentiating between players that are attempting to prematurely disconnect when their scores are unfavorable and players that are disconnected due to network problems.

The advertising module 210 is responsible for maintaining advertisements (both text and graphics) and facilitating in-game delivery of advertisements to client devices (e.g., using client-based modules as described above). In one embodiment, advertisements are selected for delivery to a client device based on the user's profile data captured by the client-based module and/or a set of criteria (e.g., a user that played game A 10 times in the last 10 days should receive ads for a new version of game A). In one embodiment, the advertisements are assigned to a carousel and are rotated by title, impression count or time schedule, and a client device type. Title-based advertising may be overridden by a carrier-specific promotion. In one embodiment, advertisements are retrieved upon the start of the game (e.g., the client-based module sends a start game message, and the advertising module 210 responds by sending a text and/or graphic ad). In one embodiment, the advertising module 210 issues a new version alert message if a newer version of the game played by the user exists (e.g., the client-based module sends a start game message with the current version of the game, and the advertising module 210 responds by sending a new version alert message).

In one embodiment, the advertising module 210 allows a user to browse a list of games and displays a description and one or more screen shots for a game selected by the user from the list. In another embodiment, the advertising module 210 facilitates a download of a demo version of the game selected from the list. A demo version is a version providing only partial (restricted) game functionality. For example, the demo version may only allow the user to play the game for a limited time period (e.g., 5 minutes) or at a basic level (i.e., the demo stops once the user reaches an advanced level in the game)

In one embodiment, the advertising module 210 is responsible for selecting recipients of specific advertisements based on data stored in the databases 216 and 218 and facilitating in-game delivery of advertisements to the selected client devices. In one embodiment, the advertising module 210 is also responsible for identifying potential customers of a game, sending an invitation to try a new game to a potential customer, and upon receiving consent from a potential customer, facilitating a download of a demo version of the new game to his or her mobile device.

The billing module 212 is responsible for performing billing transactions pertaining to billable events, such as purchases and lease of content, and storing information on billing transactions in the billing database 220. In one embodiment, when the billing module 212 receives a user request to purchase a game, it sends an acknowledgment to the relevant client device (e.g., “Game A has been billed to your accounts for $3.95) and instructs the game usage controller 204 to “unlock” game A (i.e., cause game A to be available to the user) on the relevant client device. In addition, the billing module 212 may request the user to provide billing information (e.g., an identifier of a user account maintained by the game management system, a credit card number, etc.) to complete the billing transaction or to send the billing request to a corresponding network communication carrier (e.g., to be charged against the user's phone bill). In one embodiment, the billing module 212 allows the users to request and pay separately for various game related features (e.g., high score submission, multi-player messaging, chat messaging, game content upgrade, content refresh such as refresh of pictures and sound files, etc.) and non-application data (e.g., Musical Instrument Digital Interface (MIDI) files, graphics files, etc.).

In one embodiment, the billing module 212 identifies delinquent users and passes this information to the game usage controller 204, which can then “lock” the game (i.e., cause the user access to the game to be discontinued). In one embodiment, the billing module 212 is also responsible for receiving requests for billing data from carriers and importing requested data from the billing database 220 to billing systems of the carriers.

The game download module 214 is responsible for facilitating downloads of games to relevant client devices. In one embodiment, the game download module 214 stores downloadable game code. Alternatively, the game download module 214 stores information on the external location of downloadable game code (e.g., URLs of the game code available for downloading). In one embodiment, the game download module 214 also facilitates downloads of non-application data such as MIDI files, Portable Network Graphics (PNG) files, etc.

The versioning module 222 is responsible for receiving data identifying versions of games possessed by the users, determining whether new versions of the games are available, and sending messages to client devices to inform the users of the new game versions and to indicate the location of the corresponding downloadable game code.

The user account manager 224 is responsible for collecting user account information from client devices, storing this information in the user database 216, and allowing web-based user login to their accounts. The user account information may include, for example, a list of games owned, user rankings, ladders, message boards, system information, etc.

The game finder 226 is responsible for finding multiplayer games via a lobby (e.g., finding users who are waiting to play a game), and providing user access to these games.

In one embodiment, the game management system 200 may also contain an administration module (not shown) that is responsible for allowing various levels of user access to the different services and data. For example, a game publisher administrator may be granted the highest access level to all data and services provided by the game management system 200 while a carrier administrator may be granted a lower access level allowing only access to services and data provided to the users of this carrier. In one embodiment, the administration module is also responsible for providing default settings and permissions for individual carriers and allowing customization of the default settings and permissions on a carrier basis. In one embodiment, the administration module is responsible for reconfiguring the game management system 200 in real time to add a new carrier with default setting and permissions.

Because the game management system 200 provides services to users of various network communication carriers, game player communities are no longer limited to users of a specific carrier or a specific device platform. In addition, the game management system 200 allows manufactures and publishers of electronic games to develop direct relationships with players of mobile games, PC games, web-based games and console games, collect detailed information about these game players, and facilitate targeted advertisements of electronic games. Furthermore, the game management system 200 allows game players to use purchased games on various mobile devices, regardless of the carriers associated with these mobile devices.

Client-Based Module

As discussed above, each client device serviced by the game management system hosts a client-based module (referred to herein as a gaming data module) that may be integrated with a game application (e.g., a mobile game application, a PC game application, a web-based game application, a console game application, etc.) or operate as an independent application. In one embodiment, the gaming data module is an application programming interface (API) that may vary depending on the game type. For example, a client API for a PC game may retrieve system information about the PC (e.g., disk and memory sizes, operating system information, video card type, etc.) and send this system information to the game management system 102. In addition, client API features may vary for different games. For example, a client API for a specific game may not support in-game advertising or game metric collection.

The gaming data module is responsible for forwarding messages (and store messages when the client device is disconnected from the network) to the game management system and supporting real-time in-game features (e.g., in-game advertisement, multi-player gameplay, user registration, game metric collection, etc.) facilitated by the game management system.

FIG. 2B is a block diagram of one embodiment of a gaming data module 240. The gaming data module 240 includes a billing component 242, a game access component 244, a high score component 246, a versioning alert component 248, an advertisement component 250, a marketing component 252, a user profile component 254, a game browser component 256, a game download component 258, and a user database 260.

The billing component 242 is responsible for sending billing data (e.g., the title of the game, the device ID, the user ID, user billing information, etc.) to the game management system, receiving a purchase acknowledgment from the game management system, and displaying the purchase acknowledgement to the user.

The game access component 244 is responsible for sending game keys (e.g., the game title, the device ID, and the user ID) to the game management system and unlocking the game upon receiving an unlock instruction from the game management system. In one embodiment, the game access component 244 checks with the game management system each time the user starts a game to determine whether the game should be re-locked (e.g., if subscription expires, game is pirated, etc.). In one embodiment, the game access component 244 flags high priority messages (e.g., game purchase messages) to send to the game management system immediately or store in a record file for resending if service is out (e.g., if a user wants to buy the game while in the out-of-service area).

The high score component 246 is responsible for submitting the user's score to the game management system when the game is over, receiving a current list of high scores, and displaying the current list to the user.

The versioning alert component 248 is responsible for sending game version information to the game management system when the game is launched, receiving information on a newer version from the game management system, and displaying this information to the user before the game start.

The user profile component 254 is responsible for capturing user profile data and storing the user profile data in the user database 260. The user profile data may be captured based on information of interest defined by the game management system. The user profile data may specify, for example, which games the user plays on this client device, when the games are played, user scores earned in the games, user device information (e.g., device type, CPU, etc), etc.

The advertisement component 250 is responsible for sending new user profile data to the game management system, receiving ads selected by the game management system based on the user profile data and a set of rules, and displaying the ads to the user.

The marketing component 252 is responsible for collecting game metrics and sending them to the game management system. The game metrics may specify, for example, the version of a played game, the score of the game, how long the game was played, etc.

The game browser component 256 allows users to log in at game launch, view their preferences, and browse current games available at the game management system. In one embodiment, the game browser component 256 also allows users to view games' screenshots, descriptions and price.

The game download component 258 allows users to download new games.

Use of Electronic Games with Different Devices of a User

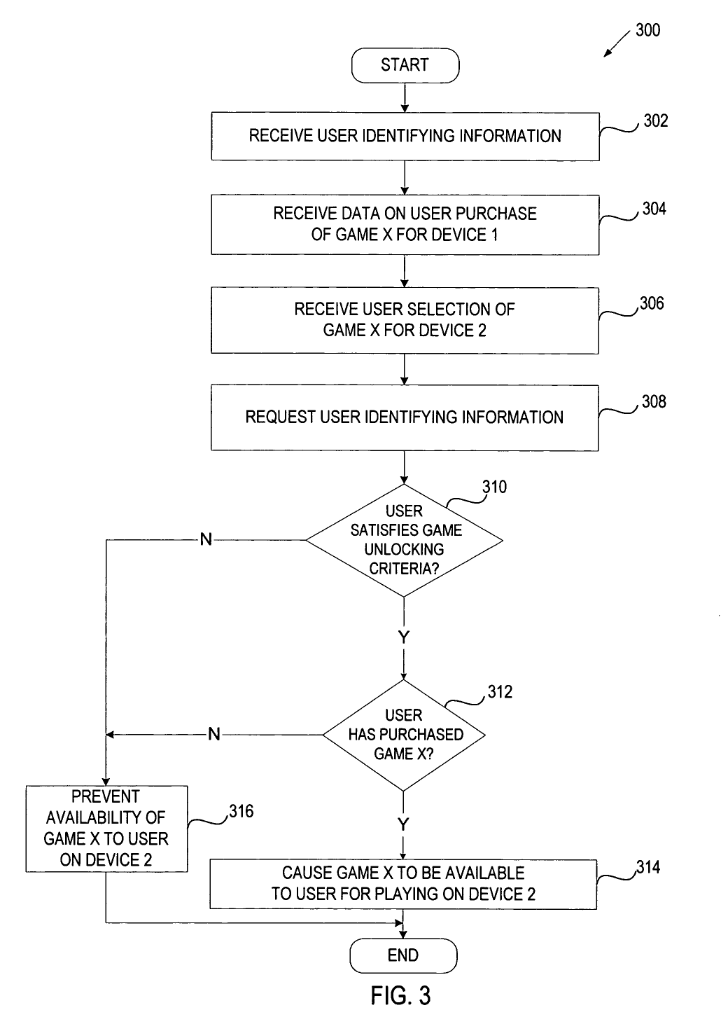

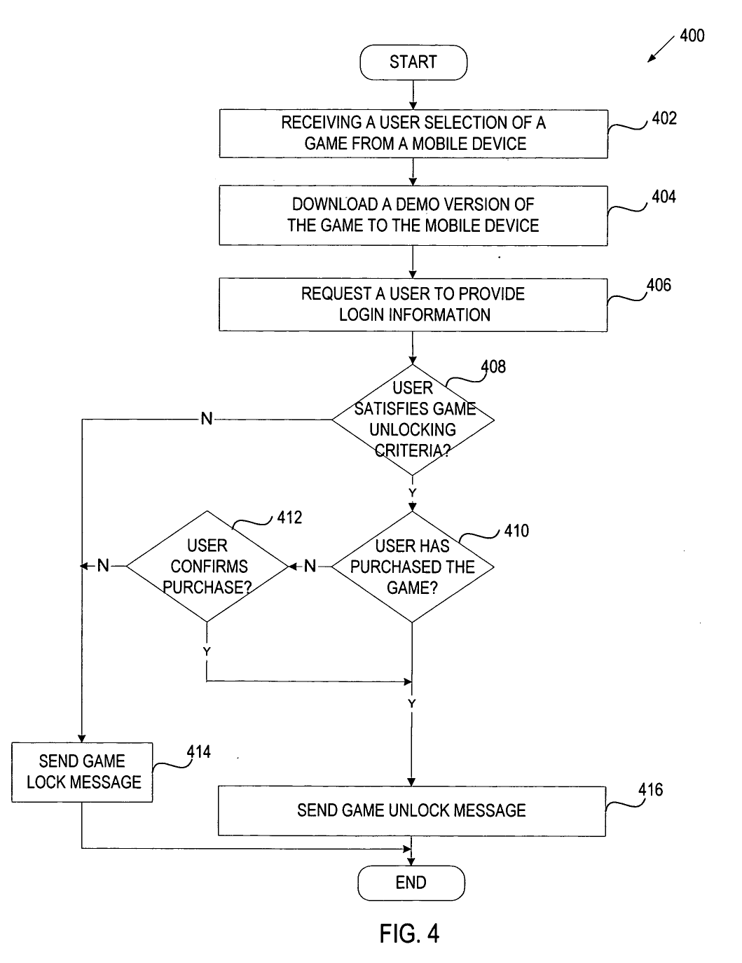

FIGS. 3 and 4 are flow diagrams of two embodiments of a process for facilitating usage of an electronic game with different devices of a user. The process may be performed by processing logic that may comprise hardware (e.g., dedicated logic, programmable logic, microcode, etc.), software (such as run on a general purpose computer system or a dedicated machine), or a combination of both. In one embodiment, the process is performed by a game management system 102 or 200.

Referring to FIG. 3, process 300 begins with processing logic receiving user identifying information when the user registers with a game management system (processing block 302). The user identifying information may include, for example, a user ID, a password, an email address, a unique code associated with the game selected by the user (e.g., a scratch card number of a purchase at a retail store), etc. The user may register with the game management system upon activating a registration link on a web site associated with the game management system or upon submitting a request to purchase the game from the game management system. Alternatively, processing logic may send a message asking the user to register with the game management system when the user issues a request to download a game to the user's device (e.g., the user's mobile phone) or when the user starts playing a new game.

At processing block 304, processing logic receives data identifying game X purchased by the user for device 1. Device 1 may be, for example, a mobile device (e.g., a cellular phone), a PC, a game station, a consumer electronic device, etc. The data identifying game X may be received when the user registers with the game management system or subsequent to the user registration. For example, the data identifying game X may be received when the user purchases game X from the game management system or when the user enters the number of a game scratch card purchased at a retail store on device 1. Processing logic stores the user identifying information and the data specifying game X in a database.

Subsequently, processing logic receives a user selection of game X for device 2 (processing block 306). Device 2 may be a mobile device of the same or different carrier than the carrier of device 1, a PC, a game station, a consumer electronic device, etc. Processing logic may receive user selection of game X for device 2 upon a user selection of game X for device 2 on a web site associated with the game management system or upon a user request from device 2 to download game X.

Next, processing logic asks the user to provide his or her identifying information (processing block 308). Alternatively, processing logic may receive user identifying information prior to receiving the user selection of game X for device 2. At decision box 310, processing logic determines whether the user satisfies one or more game unlocking criteria. The game unlocking criteria specify configurable parameters for permitting the use of the game (i.e., for “unlocking” the game). The game unlocking criteria may be different for different game types and/or different carriers. The game unlocking criteria may require, for example, that the number of “unlocks” for a user be below a predefined threshold, that the number of “unlocks” for a single user device be below a predefined threshold, that the user be not delinquent, etc.

If the determination made at decision box 310 is positive, processing logic searches the database for matching user identifying information and game data. If the match is found (decision box 312), processing logic decides that game X has been previously purchased by the user and causes game X to be available to the user for playing on device 2 (processing block 314). In one embodiment, processing logic makes game X to be available to the user by downloading game X to device 2. In another embodiment, processing logic makes game X to be available to the user by sending an unlock message to game X (e.g., to a client API associated with game X), as will be discussed in more detail below.

Alternatively, if the user does not satisfy the game unlocking criteria and/or has not previously purchased the game, processing logic prevents availability of game X to the user on device 2 (processing block 316). In one embodiment, processing logic prevents the availability of game X by preventing the download of game X to device 2. In another embodiment, processing logic prevents the availability of game X by sending a lock message to game X (e.g., to a client API associated with game X), as will be discussed in more detail below.

In an alternative embodiment (not shown), processing logic determines whether the user satisfies the game unlocking criteria after determining that the user has previously purchased the game.

If the user is allowed to play game X on device 2, processing logic supports the user's gameplay and facilitates in-game advertising and multi-player gameplay features discussed above. In one embodiment, the multi-player gameplay features are provided for multiple users across different carriers (e.g., a list of scores for the game is maintained for all participants, regardless of corresponding carriers). In addition, processing logic receives metrics associated with game X from device 2 and stores the game metrics in a database with game metrics received from other devices of the user, thus maintaining a complete set of user metrics relating to a game, regardless of a user device on which this game was played.

FIG. 4 is a flow diagram of an alternative embodiment of a process for facilitating usage of an electronic game with different devices of a user.

Referring to FIG. 4, process 400 begins with processing logic receiving a user selection of a game from a mobile device. The mobile device is associated with a first wireless carrier. In one embodiment, processing logic receives the user selection of the game upon a user request to download the game to the mobile device associated with the first wireless carrier. Then, at processing block 404, processing logic downloads a demo version of the game to the mobile device of the first wireless carrier.

In an alternative embodiment (not shown), processing logic receives the user selection of the game upon a user selection of a demo version of the game previously downloaded to the mobile device of the first wireless carrier (e.g., as part of advertising).

At processing block 406, processing logic requests the user to provide login information (e.g., user ID and password). This request may be sent to the mobile device before or after the user request to download the game or after the demo version of the game is downloaded to the mobile device (e.g., when the demo stops due to imposed restrictions).

Next, processing logic determines whether the user satisfies one or more unlocking criteria (decision box 408). If the user does not satisfy the game unlocking criteria, processing logic sends a lock message to the mobile device (processing block 414). The lock message indicates that the restrictions imposed on the game should remain enabled.

If the user satisfies the game unlocking criteria, processing logic determines, by searching a user database, whether the user has previously purchased this game for this mobile device or a different mobile device (e.g., a mobile device of a different wireless carrier) (decision box 410). If this determination is positive, processing logic sends an unlock message to the mobile device (processing block 412). The unlock message indicates that the restrictions imposed on the demo version of the game should disabled (e.g., disabling a timer allowing the user to play the game for a limited time period). As a result, the user can now play the unrestricted version of the game on the current mobile device, without having to purchase the game for the current mobile device.

If the game has not been previously purchased by the user, processing logic asks the user to purchase the game. If the user does not confirm the purchase, processing logic sends a lock message to the mobile device (processing block 414). If the user confirms the purchase, processing logic sends an unlock message to the mobile device (processing block 412).

In another embodiment (not shown), if the game has not been previously purchased by the user, processing logic automatically bills the user account for the price of the game and sends an unlock message to the mobile device.

If the game is unlocked, processing logic may subsequently check periodically whether the user satisfies one or more game locking criteria (e.g., whether the user is delinquent, has too many instances of the game downloaded to various devices, etc.). The game locking criteria specify configurable parameters for discontinuing the user access to the game (i.e., for “locking” the game). The game locking criteria may be different for different game types and/or different carriers. If the user satisfies the game locking criteria, processing logic sends a lock message to the mobile device to discontinue the user access to the game.

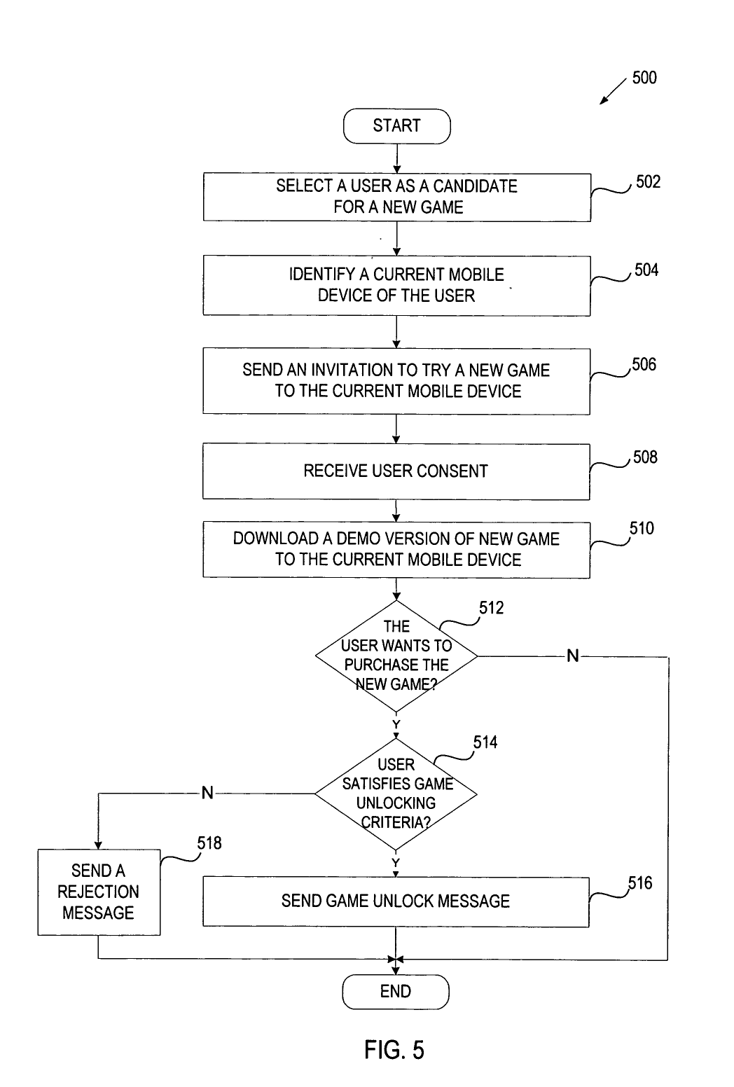

FIG. 5 is a flow diagram of one embodiment of a game advertisement process. The process may be performed by processing logic that may comprise hardware (e.g., dedicated logic, programmable logic, microcode, etc.), software (such as run on a general purpose computer system or a dedicated machine), or a combination of both. In one embodiment, the process is performed by a game management system 102 or 200.

Referring to FIG. 5, process 500 begins with processing logic selecting a user as a candidate for a new game or a new version of the existing game (processing block 502). In one embodiment, the selection is made based on data maintained by the game management system that specifies the games purchased by the user and user parameters associated with these games.

At processing block 504, processing logic identifies a current mobile device of the user. The current mobile device may be a device for which the most recent game unlock was performed or a device from which the most recent game metrics were collected.

At processing block 506, processing logic detects that the user is playing a game on the current mobile device and sends an ad with an invitation to try a new game to the current mobile device.

Next, processing logic receives user consent to try the new game (processing block 508) and downloads a demo version of the new game to the current mobile device (processing block 510).

When the demo stops due to imposed restrictions (e.g., an advanced level is reached), processing logic sends a message asking whether the user wants to purchase the new game. If the user agrees to purchase the new game (decision box 512), processing logic determines whether the user satisfies game unlocking criteria (decision box 514). If this determination is positive, processing logic sends a game unlock message to the mobile device (processing block 516), causing the game to be unlocked. Alternatively, processing logic sends a rejection message (processing block 518), notifying the user that the game cannot be unlocked.

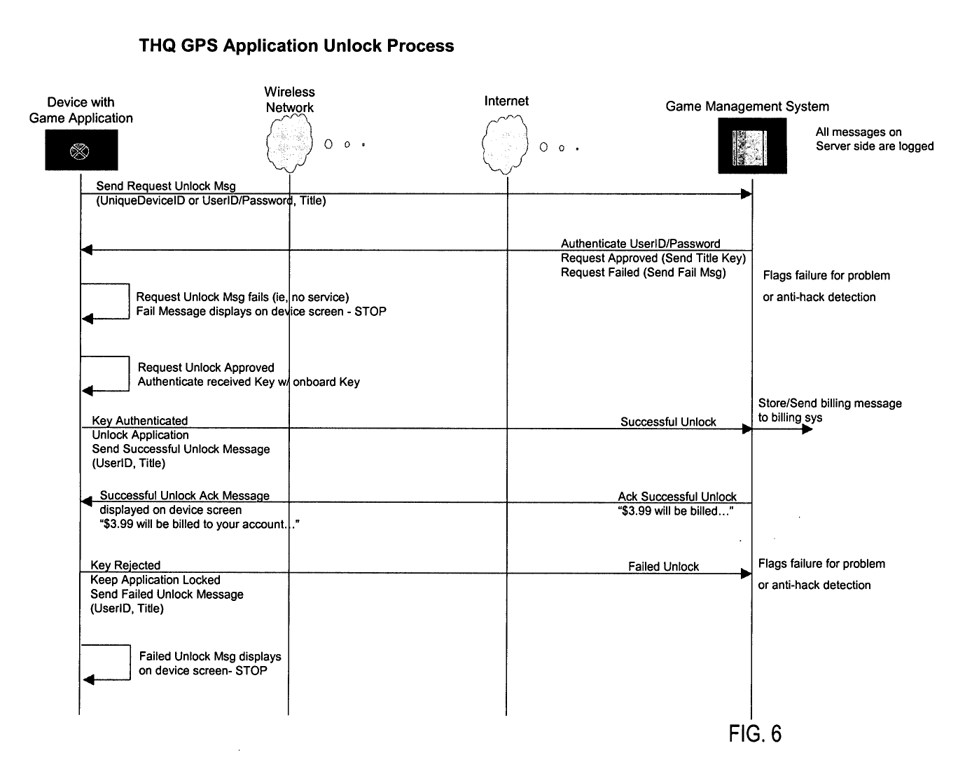

FIG. 6 illustrates one embodiment of a game unlock process. The game unlock process is performed by exchanging messages between a user device hosting a client application and a game management system via a network. The network may be a wireless network or a wide area network such as the Internet. The user device may be a mobile device, a personal computer, a game console, a consumer electronic device, etc. The client application on the user device may be configured to provide restricted gaming functionality (as a demo version) if a game is locked, and full unrestricted gaming functionality if the game is unlocked. The messages exchanged between the user device and the game management system may be, for example, hypertext transfer protocol (HTTP) messages in the form of extensible markup language (XML) strings or short message service (SMS) messages. The game management system logs all exchanged messages.

The game unlock process begins with the user device sending a message with the request to unlock the game. The message includes the title of the game that has not been purchased by the user and the user identifying information such as the identifier of the user device or the user ID and password.

In response, the game management system authenticates the user identifying information and returns a request approved message with the title key to the user device if the user identifying information is valid. Alternatively, if the user identifying information is invalid, the game management system sends a request failed message to the user device and records failure as indication of anti-hack detection or some other problem.

Next, if the user device does not receive a request approved message (e.g., if no service was provided when the game unlock message was sent) or receives a request failed message, the user device displays a request failed message to the user. Alternatively, if the user device receives a request approved message, the user device authenticates the received title key with the title key stored on the user device. If the two keys match, the user device unlocks the game and sends a successful unlock message with the user ID and the game title to the game management system, which stores a successful unlock message, sends a billing message to a billing system, and returns to the user device an acknowledgment of the unlock with information on the resulting billing transaction (e.g., “$3.99 will be billed to your account . . . ”). The user device receives the unlock acknowledgement message and display it to the user.

If the title key received from the game management system does not match the title key stored on the user device, the user device keeps the game locked, sends an unlock failed message to the game management system and displays the unlock failed message to the user. The game management system records the failed unlock as indication of anti-hack detection or some other problem.

In some embodiments, the game unlock mechanism may be used to enable a coin-op game model which resembles a standard arcade game requiring one or more coins for each start of the game. According to the coin-op game model, the game is automatically locked when it is completed. If the user requests to restart the game, the user is asked to approve unlocking of the game. When such an approval is received, the user account is charged with a fee, and the game is unlocked until the next completion. Alternatively, the user account may be credited in response to the restart request to encourage the user's replays of the game.

In yet other embodiments, the game unlock mechanism may be used to enable a bundle game model that allows only operation of selected games on a user device. According to the bundle game model, a group of games (e.g., the entire catalog of games) is downloaded to a user device, and then some of these games are unlocked while others remain locked. The selection of games to be unlocked may be based on predefined business rules. For example, a user may subscribe for a certain number of games or specific games during a predefined time interval (e.g., a month), and only these games will be unlocked during this subscription term. The remaining games will not operate during the subscription term event though they reside on the client device.

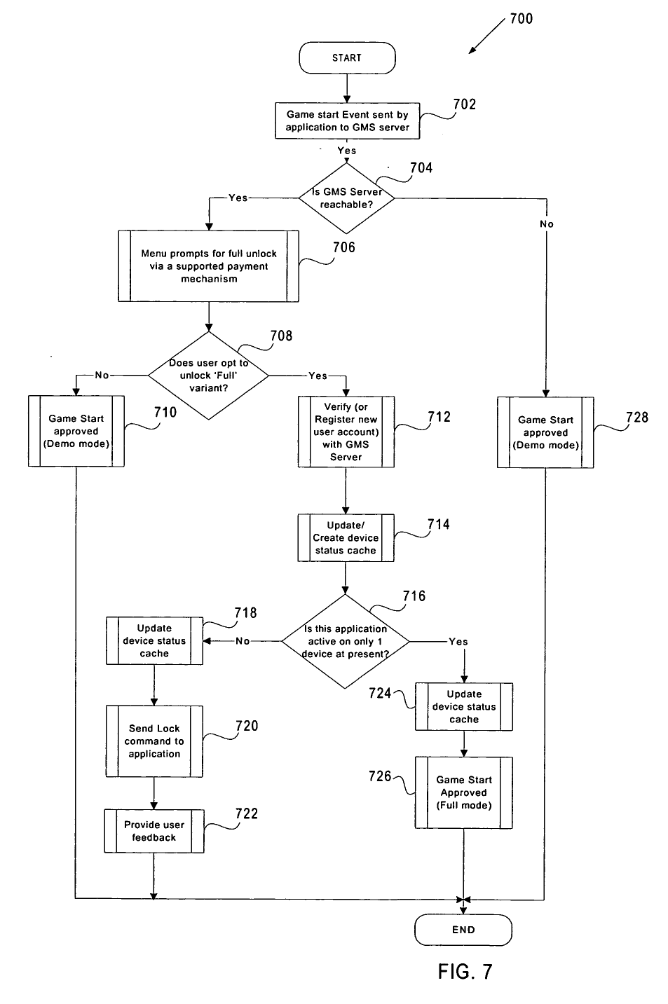

FIGS. 7-12 are flow diagrams illustrating various embodiments of game unlocking processes.

Referring to FIG. 7, a game unlocking process 700 allows a client device to create a status cache that is subsequently used when a game management system (GMS) server is unavailable. The GMS server may be unavailable if, for the example it is down for service, the client device does not have network access, or for any other reason. The status cache may specify the status of the game, when the game was last played, the mode in which the game was played, etc.

At block 702, an application residing on the client in a demo mode (i.e., the mode associated with limited functionality, advertisement insertion pre-launch, etc.) sends a game start event to the GMS server.

At block 704, the client application determines whether the GMS server is reachable. If not, the client application approves the start of the game in the demo mode (block 728). If so, the client application allows the user to approve full (unrestricted) unlock of the game (block 706). In one embodiment, the user can approve the full unlock by paying for the game via any available payment mechanism.

If the user does not choose full unlock, the client application approves the start of the game in the demo mode (block 710). Alternatively, if the user selects full unlock, the GMS server verifies the user account (or creates an account for a new user) with the GMS server (block 712), instructs the client application to create a device status cache (block 714), and determines whether this game is currently active on this device only (block 716). If so, the GMS server instructs the client application to update the device status cache with data indicating that the user is authorized to use this game (block 724) and sends an approval for starting the game in the full mode (block 726).

If this game is currently active on more than one device, the GMS server instructs the client application to update the device status cache with data indicating that the user is not authorized to use this game (block 718) and sends a lock command to the client application (block 720). The client application locks the game and displays a user feedback (block 722) that may be created based on business rules and may include instructions on how to unlock the game. For example, the feedback may include a game purchase link, a notice that the game is running on another handset on this user's login, etc. In addition, context-sensitive help may be provided (e.g., a message asking the user to retry after verifying that no one else in the family is logged-in on another device).

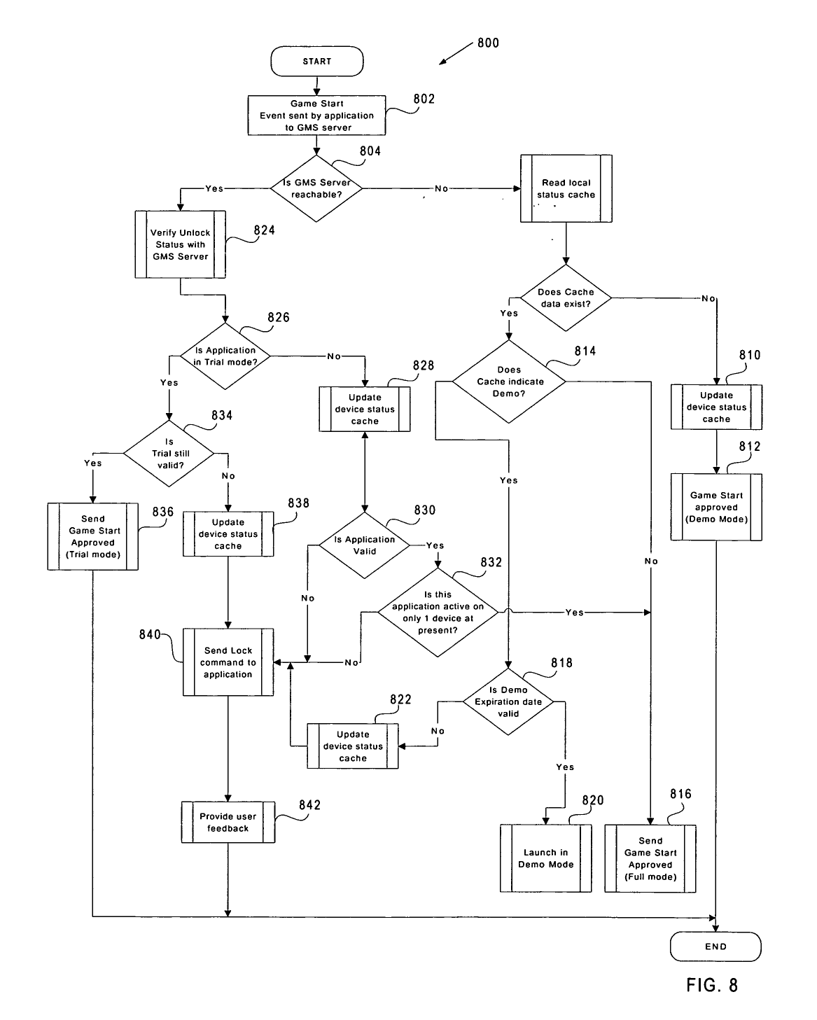

Referring to FIG. 8, a game unlocking process 800 allows a client device to use a status cache when the GMS server is unavailable. The status cache may specify the status of the game, when the game was last played, the mode in which the game was played, the terms of the trial period, etc.

At block 802, an application residing on the client sends a game start event to the GMS server.

At block 804, the client application determines whether the GMS server is reachable. If not, the client application reads the status cache residing on the client device (block 806). If the status cache does not include any data (block 808), the client application updates the status cache (block 810) and approves the start of the game in the demo mode (block 812).

If the status cache includes data (block 808), the client application determines whether the cache data indicates that the user is authorized to play the game in the demo or full mode (block 814). If the user is authorized to play the game in the full mode, the client application approves the start of the game in the full mode (block 816).

If the user is authorized to play the game in the demo mode, the client application checks whether the demo mode has expired (block 818). If not, the game is launched in the demo mode (block 820). If so, the client application updates the status cache (block 822), locks the game (block 840) and displays feedback tot he user (block 842) that may be created based on business rules and may include instructions on how to unlock the game and context-sensitive help.

If the GMS server is reachable (block 804), the client application requests the GMS server to verify the unlock status of the user (block 824). The GMS server then determines whether the game is in trial mode (e.g., downloaded to be played for free for evaluation) (block 826). If so, the GMS server determines whether the trial mode is still valid (e.g., using business rules such as the number of allowed tries, an allowed time period, etc.) (block 834). If the trial mode is still valid, the GMS server approves the game start in the trial mode (block 836).

If the trial mode is no longer valid, the GMS server instructs the client application to update the device status cache (block 838) and sends the lock command to the client application (block 840), which then locks the game and displays feedback to the user (block 842).

If the game is not in the trial mode (i.e., it is in the production mode) (block 826), the GMS server instructs the client application to update the device status cache (block 828) and determines whether the game is valid (e.g., whether it was previously purchased by the user) (block 830). If not, the GMS server sends the lock command to the client application (block 840), which then locks the game and displays feedback to the user (block 842). If so, the GMS server determines whether this game is currently active on this device only (block 832). If so, the GMS server sends an approval for starting the game in the full mode (block 816).

If this game is currently active on more than one device, the GMS server sends the lock command to the client application (block 840). The client application then locks the game and displays feedback to the user (block 842).

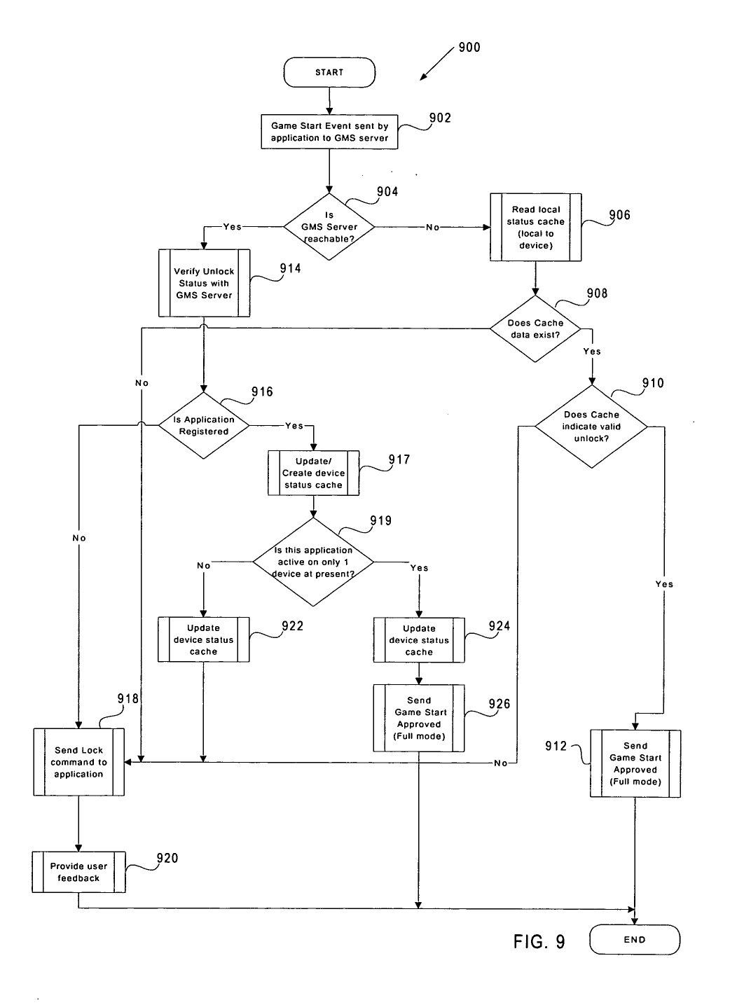

Referring to FIG. 9, a game unlocking process 900 allows a client device to use a status cache for the full unlock mode when the GMS server is unavailable.

At block 902, an application residing on the client sends a game start event to the GMS server.

At block 904, the client application determines whether the GMS server is reachable. If not, the client application reads the status cache residing on the client device (block 906). If the status cache does not include any data (block 908), the client application locks the game (block 918) and displays feedback to the user (block 920).

If the status cache includes data (block 908), the client application determines whether the cache data indicates that the user is authorized to play the game in the full mode (block 910). If so, the client application approves the start of the game in the full mode (block 912).

If the user is not authorized to play the game in the full mode, the client application locks the game (block 918) and displays feedback to the user (block 920).

If the GMS server is reachable, the client application verifies the unlock status of the user with the GMS server (block 914). If the game is registered (e.g., it has been previously purchased) (block 916), the GMS server instructs the client application to update the device status cache (block 917), and determines whether this game is currently active on this device only (block 919). If so, the GMS server instructs the client application to update the device status cache with data indicating that the user is authorized to use this game (block 924) and sends an approval for starting the game in the full mode (block 926).

If this game is currently active on more than one device, the GMS server instructs the client application to update the device status cache with data indicating that the user is not authorized to use this game (block 922) and sends a lock command to the client application (block 918). The client application locks the game and displays feedback to the user (block 920).

If the game is not registered (e.g., it has not been previously purchased) (block 916), the GMS server sends a lock command to the client application (block 918). The client application locks the game and displays feedback to the user (block 920).

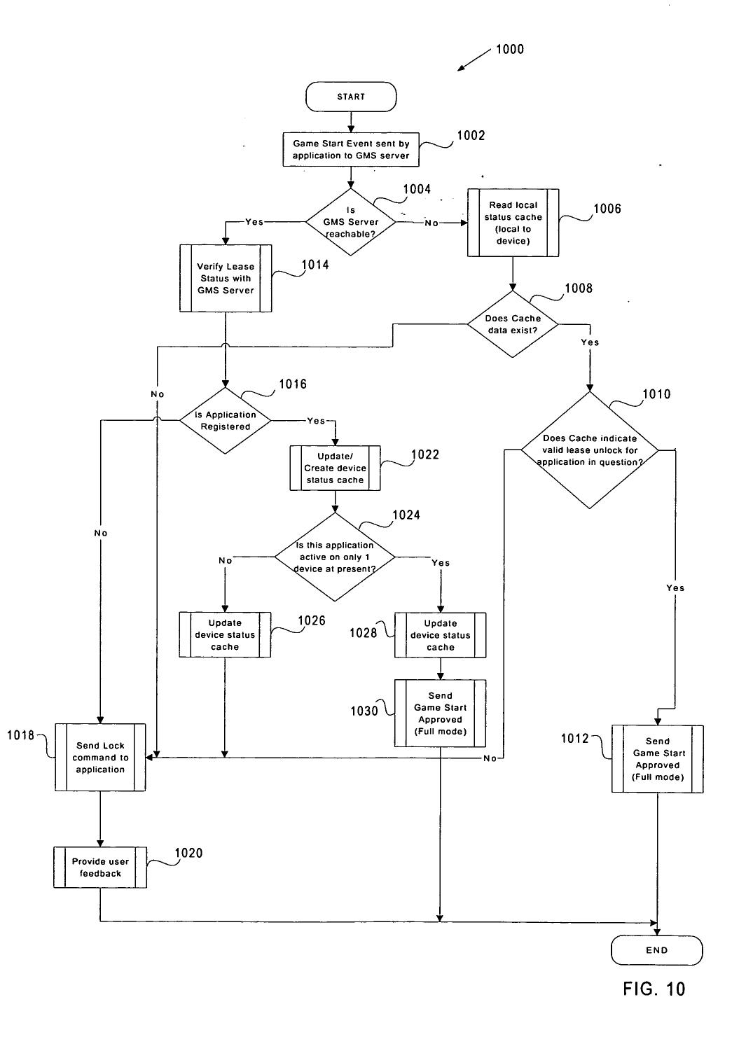

Referring to FIG. 10, a game unlocking process 1000 pertaining to game leasing (e.g., the user pays to lease the game for a predefined time period) allows a client device to use a status cache for the full unlock mode when the GMS server is unavailable. The status cache may specify the status of the game, when the game was last played, the mode in which the game was played, the terms of the lease, etc.

At block 1002, an application residing on the client sends a game start event to the GMS server.

At block 1004, the game application determines whether the GMS server is reachable. If not, the client application reads the status cache residing on the client device (block 1006). If the status cache does not include any data (block 1008), the client application locks the game (block 1018) and displays feedback to the user (block 1020).

If the status cache includes data (block 1008), the client application determines whether the cache data indicates that the user is authorized to play the leased game in the full mode (block 1010). If so, the client application approves the start of the game in the full mode (block 1012).

If the user is not authorized to play the leased game in the full mode, the client application locks the game (block 1018) and displays feedback to the user (block 1020).

If the GMS server is reachable, the client application verifies the lease status of the user with the GMS server (block 1014). If the game is registered (e.g., the user has paid for the lease of the game) (block 1016), the GMS server instructs the client application to update the device status cache (block 1022), and determines whether this game is currently active on this device only (block 1024). If so, the GMS server instructs the client application to update the device status cache with data indicating that the user is authorized to use this game (block 1028) and sends an approval for starting the game in the full mode (block 1030).

If this game is currently active on more than one device, the GMS server instructs the client application to update the device status cache with data indicating that the user is not authorized to use this game (block 1026) and sends a lock command to the client application (block 1018). The client application locks the game and displays feedback to the user (block 1020). In one embodiment, the GMS server issues a lock for a user account/game combination. That is, if a user shares his or her account information with others, all instances of this account/game combination will be locked to disincentivize the user from sharing his or her account information.

If the game is not registered (e.g., the user has not paid for the lease or the lease has expired (block 1016), the GMS server sends a lock command to the client application (block 1018). The client application locks the game and displays feedback to the user (block 1020).

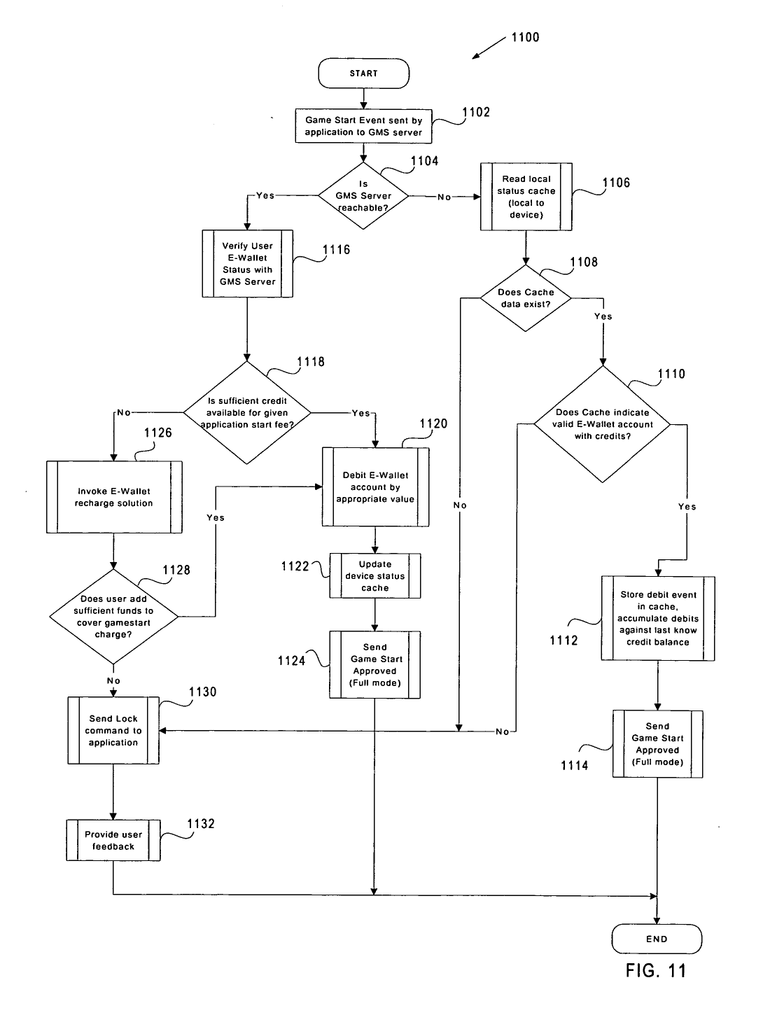

Referring to FIG. 11, a game unlocking process 1100 pertaining to the coin-op game model allows a client device to use a status cache for the full unlock mode when the GMS server is unavailable. The status cache may specify the status of the game, when the game was last played, the mode in which the game was played, the status of the user's e-wallet account to be charged each time the game is restarted, etc.

At block 1102, an application residing on the client sends a game start event to the GMS server.

At block 1104, the client application determines whether the GMS server is reachable. If not, the client application reads the status cache residing on the client device (block 1106). If the status cache does not include any data (block 1108), the client application locks the game (block 1130) and displays feedback to the user (block 1132).

If the status cache includes data (block 1108), the client application determines whether the cache data indicates that the user's e-wallet account is valid and has funds (block 1100). If so, the client application stores a debit event in the cache and accumulates debits against the last known credit balance (block 1112), and approves the start of the game in the full mode (block 1114).

If the cache data indicates that the user's e-wallet account is not valid or does not have funds, the client application locks the game (block 1130) and displays feedback to the user (block 1132).

If the GMS server is reachable, the client application verifies the status of the user's e-wallet account with the GMS server (block 1116). If a sufficient credit is available to cover the start fee for this game (block 1118), the GMS server debits the e-wallet account by the amount of the start fee (block 1120), instructs the client application to update the device status cache (block 1122), and sends an approval for starting the game in the full mode (block 1124). In one embodiment, the user is asked to approve a charge against his or her e-wallet each time a billable event occurs. In an alternative embodiment, the e-wallet is charged automatically, without requesting the user's approval.

If the e-wallet account does not contain sufficient funds to cover the start fee for this game (block 1118), the GMS server invokes an e-wallet recharge solution, offering the user to add funds to the e-wallet account (block 1126). If the user adds enough funds to the account the GMS server returns to block 1120. Otherwise, the GMS server sends a lock command to the client application (block 1130). The client application locks the game and displays feedback to the user (block 1132).

In alternative embodiments, the user's e-wallet account may be credited based on gaming parameters (e.g., high scores, etc.). For example, contests may be maintained, with e-wallet currency as reward against which users could charge (e.g., for games, or other premium application services). This currency may be tracked separately from actual e-wallet currency, so that, for example, a user who purchased 10 applications via reward currency cannot request a credit on charges incurred, and the conversion of virtual currency to actual currency may not be allowed.

In yet other embodiments, Premium SMS messages may be used to “charge” the user's e-wallet account (e.g., when a carrier cannot be billed directly). For example, the user may register an account with his or her phone number, and sends an SMS message to the GMS server. This triggers a Premium SMS response, which, if accepted, credits the user's e-wallet account for the value of the Premium SMS message. This then becomes a virtual bank against which a user can charge (for unlocks, leases, coin-op, etc.). Once exhausted, the coin-op and any recurring lease models ‘expire’ until the e-wallet account is recharged. For example, there may be a recurring charge defined by the lease model (e.g., a sports package might cost 5 dollars per month), which may then either be debited against an e-wallet account or billed to an alternate clearinghouse (a sports league, the carrier itself, etc). Then, depending on whether this charge is accepted or denied, the unlock mechanism reacts accordingly.

Combinations of the above methods are possible. For example, a minimum credit may be maintained on file for new users or for users with a charge-back history, and a user may have a defined lower-limit on credit (e.g., 5 dollars). When this limit is reached, the GMS server may attempt to process real-time charges against the carrier or other billing provider, but the applications may still function until the balance reaches zero.

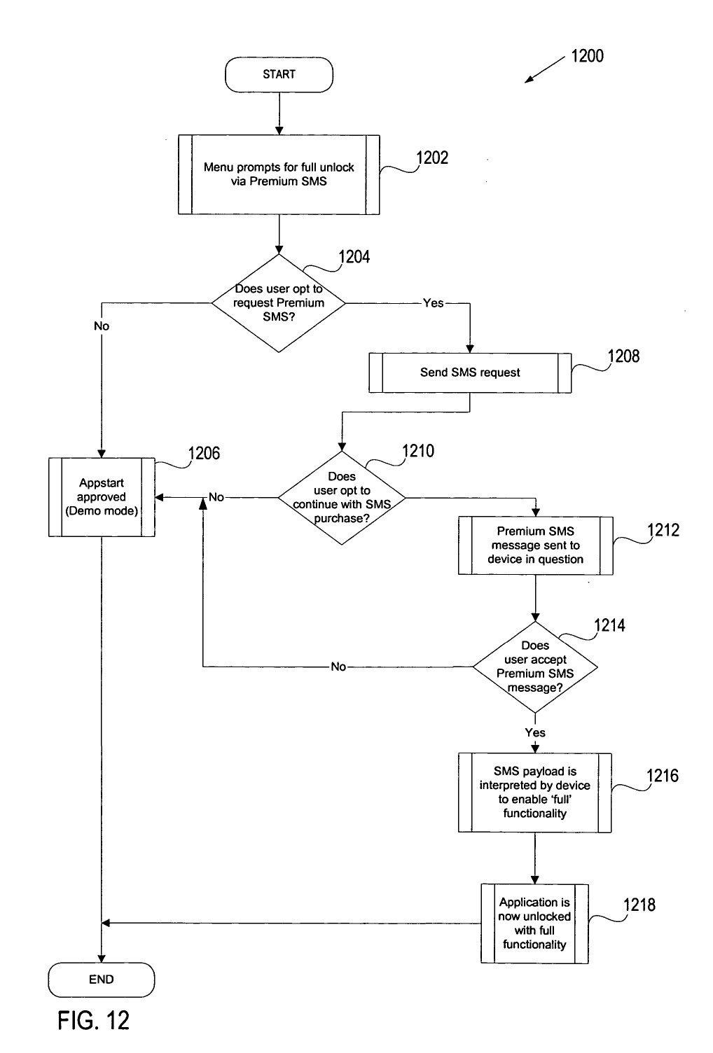

Referring to FIG. 12, a game unlocking process 1200 utilizing Premium SMS messages is illustrated. The process 1200 may be performed by a system of a carrier that provides embedded games in demo mode.

At block 1102, a client application displays a menu prompting a user to approve full unlock via a Premium SMS message sent to the client device of the user.

At block 1204, the client application determines whether the user agrees to request the full unlock via the Premium SMS message (i.e., whether the user agrees to pay the amount of the Premium SMS). If not, the client application approves the start of the game in the demo mode (block 1206). If so, the client application sends an SMS request (block 1208) and determines whether the user chooses to continue with the SMS purchase (block 1210).

If the user does not wish to continue with the SMS purchase, the client application approves the start of the game in the demo mode (block 1206). Otherwise, a Premium SMS message is sent to the user's client device (block 1212). If the user accepts the Premium SMS message (block 1214), the SMS payload is interpreted by the client device to enable full functionality (block 1216), resulting in the application being unlocked in full mode (block 1218).

If the user does not accept the Premium SMS message (block 1214), the client application approves the start of the game in the demo mode (block 1206).

An Exemplary Computer System

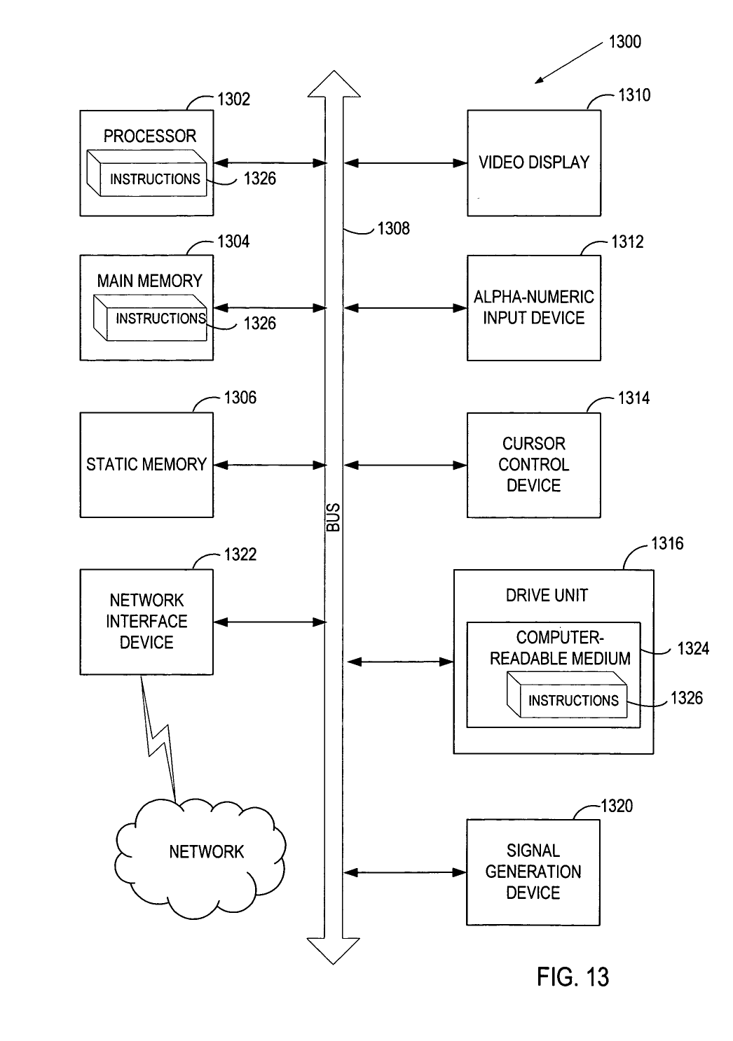

FIG. 13 is a block diagram of an exemplary computer system 1300 that may be used to perform one or more of the operations described herein. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 1300 includes a processor 1302, a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alpha-numeric input device 1312 (e.g., a keyboard), a cursor control device 1314 (e.g., a mouse), a disk drive unit 1316, a signal generation device 1320 (e.g., a speaker) and a network interface device 1322.

The disk drive unit 1316 includes a computer-readable medium 1324 on which is stored a set of instructions (i.e., software) 1326 embodying any one, or all, of the methodologies described above. The software 1326 is also shown to reside, completely or at least partially, within the main memory 1304 and/or within the processor 1302. The software 1326 may further be transmitted or received via the network interface device 1322. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to included, but not be limited to, solid-state memories, optical and magnetic disks, and carrier wave signals.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
identifying a game selected by a user for a first user device;
determining that the game has been previously purchased by the user for a second user device; and
causing the game to be available to the user for playing on the first user device.

2. The method of claim 1 wherein:
the first user device is a wireless device associated with a first wireless carrier; and
the second user device is wireless device associated with a second wireless carrier.

3. The method of claim 1 wherein:
the first user device is a wireless device; and
the second user device is any one of a personal computer, a hand-held computer, and a video game console.

4. The method of claim 1 wherein determining that the game has been previously purchased by the user comprises:
receiving user identifying information; and
finding matching user identifying information associated with the game in a database.

5. The method of claim 4 further comprising:
receiving the matching user identifying information when the user purchases the game for the second user device; and
storing the matching user identifying information in association with the game in the database.

6. The method of claim 4 wherein the user identifying information comprises a user identifier and a password.

7. The method of claim 4 wherein the user identifying information comprises a unique code associated with the game.

8. The method of claim 1 further comprising:
prior to causing the game to be available to the user, determining that the user satisfies one or more game unlocking criteria.

9. The method of claim 1 further comprising:
determining that the user satisfies one or more game locking criteria; and
causing user access to the game to discontinue.

10. The method of claim 1 wherein identifying the game selected by the user comprises:
detecting a user request to download a demo version of the game to the first user device.

11. The method of claim 10 wherein the demo version of the game provides restricted functionality of the game.

12. The method of claim 11 wherein causing the game to be available to the user comprises:
causing restrictions associated with the demo version of the game to be disabled.

13. The method of claim 1 further comprising:
notifying the user about a new game;
receiving a user consent to try the new game;
downloading a demo of the new game to the first user device; and
upon determining that the user has purchased the new game, causing the new game to be available to the user for playing on the first user device.

14. The method of claim 1 further comprising:
receiving metrics of the game from the first user device; and
storing the metrics received from the first user device with the game metrics received from the second user device.

15. The method of claim 1 further comprising:
maintaining a list of scores for the game, the list of scores covering a plurality of players of the game across a plurality of device platforms; and
displaying the list of scores to the user.

16. The method of claim 1 further comprising:
analyzing stored data associated with the user; and
selecting advertisements to be displayed to the user based on the analyzed data.

17. A method comprising:
receiving from a wireless device a request to unlock a game residing on the wireless device;
determining that a user of the wireless device satisfies unlock criteria; and
communicating to the wireless device an instruction to unlock the game.

18. The method of claim 17 further comprising:
upon determining that the user of the wireless device satisfies the unlock criteria, sending a request to bill the user for a price of the game to a billing system; and
sending data identifying a billed amount to the wireless device.

19. The method of claim 17 wherein:
the game residing on the client device operates in a restricted mode prior to unlocking; and
the instruction to unlock the game causes the game to operate in a full mode.

20. The method of claim 17 further comprising:
determining that the user does not satisfy the unlocking criteria; and
communicating to the wireless device an instruction to lock the game.

21. The method of claim 17 further comprising:
determining that the game is active only on one wireless device prior to communicating the instruction to unlock the game.

22. A method comprising:
receiving, from a client device, a request to unlock a game each time a user of the client device attempts to start the game; and
communicating to the client device an instruction to unlock the game each time a billable event is issued for starting the game.

23. The method of claim 22 wherein the game is automatically locked each time the game is completed.

24. The method of claim 22 wherein the billable event is issued upon receiving a request of the user to unlock the game.

25. The method of claim 24 further comprising:
causing an account of the user to be charged with a fee for starting the game when receiving the request of the user to unlock the game.

26. The method of claim 22 wherein the billable event is issued upon determining that an e-wallet account of the user contains funds sufficient to cover a fee for starting the game.

27. The method of claim 26 further comprising:
debiting the e-wallet account of the user for the fee.

28. The method of claim 26 further comprising:
determining that the e-wallet account of the user does not contain funds sufficient to cover the fee for starting the game;
allowing the user to recharge the e-wallet account; and
determining that the user added funds sufficient to cover the fee for starting the game to the e-wallet account.

29. The method of claim 22 wherein the client device is any one of a mobile phone, a personal computer, a hand-held computer, and a video game console.

30. A system comprising:
a database to store data pertaining to a user; and
a game usage controller to identify a game selected by the user for a first user device, to search the database to determine that the game has been previously purchased by the user for a second user device, and to cause the game to be available to the user for playing on the first user device.

31. A system comprising:
a database to store data pertaining to a user of a wireless device; and
a game usage controller to receive from the wireless device a request to unlock a game residing on the wireless device, to determine that a user of the wireless device satisfies unlock criteria using the data pertaining to the user, and to communicate to the wireless device an instruction to unlock the game.

32. A system comprising:
a game usage controller to receive, from a client device, a request to unlock a game each time a user of the client device attempts to start the game, and to communicate to the client device an instruction to unlock the game each time a billable event is issued for starting the game.

33. An apparatus comprising:
means for identifying a game selected by a user for a first user device;
means for determining that the game has been previously purchased by the user for a second user device; and
means for causing the game to be available to the user for playing on the first user device.

34. An apparatus comprising:
means for receiving from a wireless device a request to unlock a game residing on the wireless device;
means for determining that a user of the wireless device satisfies unlock criteria; and
means for communicating to the wireless device an instruction to unlock the game.

35. An apparatus comprising:
means for receiving, from a client device, a request to unlock a game each time a user of the client device attempts to start the game; and
means for communicating to the client device an instruction to unlock the game each time a billable event is issued for starting the game.

36. A computer readable medium comprising executable instructions which when executed on a processing system cause said processing system to perform a method comprising:
identifying a game selected by a user for a first user device;
determining that the game has been previously purchased by the user for a second user device; and
causing the game to be available to the user for playing on the first user device.

37. A computer readable medium comprising executable instructions which when executed on a processing system cause said processing system to perform a method comprising:
receiving from a wireless device a request to unlock a game residing on the wireless device;
determining that a user of the wireless device satisfies unlock criteria; and
communicating to the wireless device an instruction to unlock the game.

38. A computer readable medium comprising executable instructions which when executed on a processing system cause said processing system to perform a method comprising:
receiving, from a client device, a request to unlock a game each time a user of the client device attempts to start the game; and
communicating to the client device an instruction to unlock the game each time a billable event is issued for starting the game.
